(19) United States
(12) Patent Application Publication
(10) Pub. No.: US 2003/0009379 A1
(43) Pub. Date: Jan. 9, 2003

(54) System and method for providing an automatic purchase reward

(76) Inventors: Ashok Narasimhan, Los Altos Hills, CA (US); Vas Raman, Los Altos Hills, CA (US); Bernard David, Wilmington, DE (US)

Correspondence Address: Mark I. Crohn, Hendricks & Lewis, Suite 2675, 999 Third Ave., Seattle, WA, 98104, US

(21) Appl. No.: 10/175,560

(22) Filed: Jun. 17, 2002

Related U.S. Application Data
(63) Continuation of application No. 08/914,850, filed on Aug. 18, 1997, now abandoned.
Application No. 08/914,850 is a continuation-in-part of application No. 08/696,705, filed on Aug. 14, 1996, now Pat. No. 6,237,145.
Application No. 08/696,705 is a continuation-in-part of application No. 08/466,270, filed on Jun. 6, 1995, now abandoned.

(51) Int. Cl. G06F 17/60

(52) U.S. Cl. 705/14

(57) ABSTRACT

A system and method for accessing promotion information and for generating available rewards therefrom is disclosed. The system stores a plurality of promotion information records, where each record includes an available reward in connection with a purchase from a vendor. The system also stores a user profile for a system user which includes user preference information based upon preferences of the user. The stored promotion information records are presented to the user. Such user selects records for presentation and selects the available reward of a record. The selected available reward is the stored for the user. A reward is issued to the user upon presentation of a pre-determined account identifier to a vendor in connection with a purchase for which the available reward has been stored. The account identifier identifies an account from which funds are to be transferred to the vendor. A transaction record corresponding to the purchase is received, and includes the account identifier and a first amount of funds to be debited from the identified account. The received transaction record is compared with the selected available reward to determine that the reward should be issued based on the purchase and the available reward. Based on such determination, the identified account is credited for a second amount of funds based on the reward.

### CROSS-REFERENCE TO RELATED APPLICATION

This is a continuation-in-part of U.S. patent application Ser. No. 08/696,705, filed Aug. 14, 1996, which is in turn a continuation-in-part of U.S. patent application Ser. No. 08/466,270, filed Jun. 6, 1995.

### FIELD OF THE INVENTION

The present invention relates to a system and method for providing an automatic purchase reward based at least in part on the accession by a user of promotion information. More particularly, the present invention relates to such a system and method wherein the reward is a credit to an account debited as a result of the purchase.

### BACKGROUND OF THE INVENTION

Discount coupons and other similar “rewards” are conventionally offered by manufacturers and retailers in newspapers, in magazines, by direct mail, and the like to entice members of the public to buy a particular product or service. As is well known, such coupons are usually targeted to specific types of consumers, and such targeting may be performed in a highly sophisticated manner. Nevertheless, the fact remains that the redemption rate for coupons in many situations may be in the range of one to two percent. A major reason for such a low rate is that many coupons offered to a particular consumer are rejected by that consumer simply for lack of interest. Further, even if a consumer wishes to take advantage of a coupon offer, the consumer may be prevented from doing so based on the inability to redeem the coupon at a specified location and/or before a specified expiration date.

Moreover, the consumer may be hindered from taking advantage of the coupon offer merely by the fact that the process of redeeming the coupon can be cumbersome. For example, coupon redemption typically includes the steps of locating a coupon in a magazine, newspaper, circular, or the like, clipping or otherwise removing the coupon, storing the coupon in a location from which it may be retrieved, actually retrieving the coupon prior to a relevant purchase, and actually remembering to present the coupon at the appropriate time during the purchase. If, even one of the aforementioned steps is omitted, the coupon will likely never be redeemed. As a result, ninety-eight percent or more of all offered coupons are never redeemed.

Several systems have been proposed to increase the rate of redemption of coupons by selectively printing the coupons at the consumer's request. In one such proposed system, product/service information is broadcast from a central location to a consumer's remote location in the form of a television signal or the like, and the consumer can print redeemable coupons at a generating unit at the consumer's remote location in response to the transmitted product/service information. Such a system is advantageous in that the consumer can be selective about which coupons are printed. However, such a system is also cumbersome and unrealistic in that it is essentially an unending series of television commercials, and in that the expense of broadcasting the product/service information and placing the coupon generating unit at each of a plurality of consumer's remote locations is cost prohibitive. Moreover, even if the consumer does print a coupon, the consumer must still not lose the coupon and must remember to retrieve the coupon before purchasing a relevant product/service.

In the system disclosed in U.S. patent application Ser. No. 08/696,705, filed Aug. 14, 1996 and referenced above, a consumer selects coupons for redemption after perusing promotion information, the selected coupons are electronically stored, and such coupons are electronically retrieved and redeemed by a vendor in conjunction with the purchase of a relevant item. Such a system is an improvement in that the consumer need not deal with paper coupons and the difficulties related therewith, as was discussed above. Moreover, the electronic retrieval apparatus necessary at each of a plurality of vendors is already present in the form of credit authorization hardware and/or software, or can be provided with relative ease as a stand-alone hardware device. However, such system requires extra effort on the part of the vendor in retrieving the coupons and on the part of the consumer in identifying to the vendor that coupons must be retrieved. A need exists, then, for an automatic purchase reward system and method that allows a user to obtain purchase rewards without requiring additional effort beyond that which is likely already expended in the course of a normal purchase.

### SUMMARY OF THE INVENTION

The aforementioned need is satisfied by a system and method for accessing promotion information and for generating available rewards therefrom. The system has a promotion information record storing device for storing a plurality of promotion information records. Each promotion information record includes an available reward in connection with a purchase from a vendor. The system also has a user profile storage device for storing a user profile for a system user. The user profile includes user preference information based upon preferences of the user.

A presentation device presents the stored promotion information records to the system user where the user selects promotion information records for presentation. A selecting device is employed by the user to select the available reward of a promotion information record. An available reward storing device stores the selected available reward for the user. The record of the available reward is stored in an available reward record database in connection with the user profile for the user.

A reward issuing device issues a reward to the user upon presentation by the user of a pre-determined account identifier to a vendor. The presentation takes place in connection with a purchase for which the available reward has been stored for the user in the available reward storing means. The account identifier identifies an account of the user from which funds are to be transferred to the vendor. The account is maintained and provided to the user by an account provider.

The reward issuing device includes a device for receiving a transaction record corresponding to the purchase, where the transaction record includes the account identifier and a first amount of funds to be debited from the identified account with respect to the purchase. The reward issuing device also includes a device for comparing the received transaction record and the available reward for the user in the available reward storing means to determine that the reward should be issued to the user based on the purchase corresponding to the received transaction record and based on the available reward for the user. Based on such determination, the reward issuing device credits the identified account for a second amount of funds based on the reward.

### BRIEF DESCRIPTION OF THE DRAWINGS

The foregoing summary, as well as the following detailed description of a preferred embodiment of the present invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a schematic illustration of a system for accessing and displaying promotion information in accordance with a preferred embodiment of the present invention;

FIGS. 2 and 3, respectively, are a main menu and a sub-menu displayed by the system of FIG. 1;

FIG. 4 is visual information from a promotion presented by the system of FIG. 1;

FIG. 5 is a block diagram of a system for providing a reward to a purchaser in conjunction with the system of FIG. 1; and

FIG. 6 is a flow diagram showing the processing performed by the system of FIG. 5 in conjunction with the system of FIG. 1.

### DETAILED DESCRIPTION OF PREFERRED EMBODIMENT

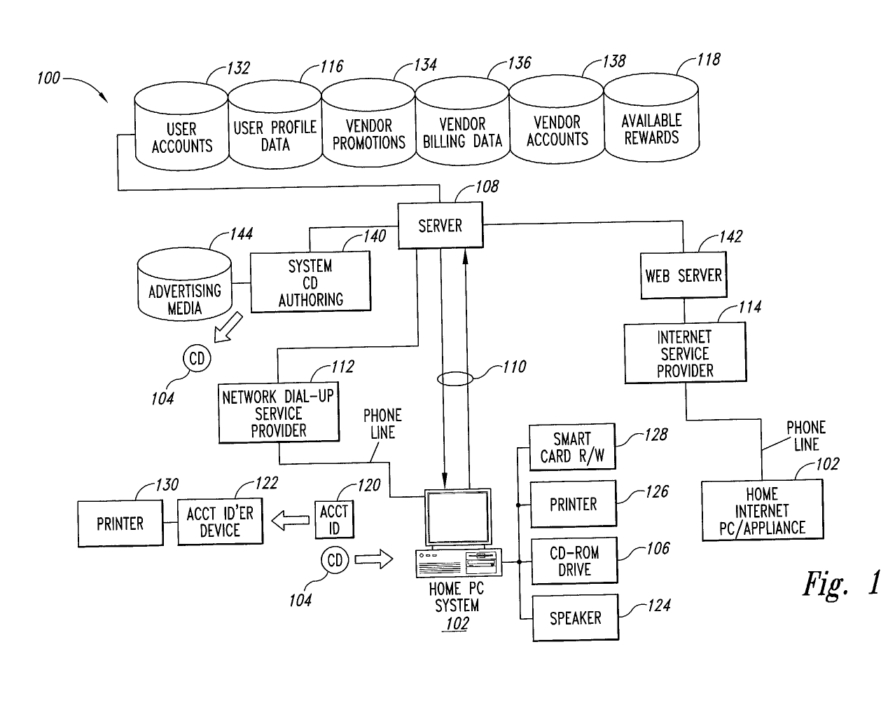

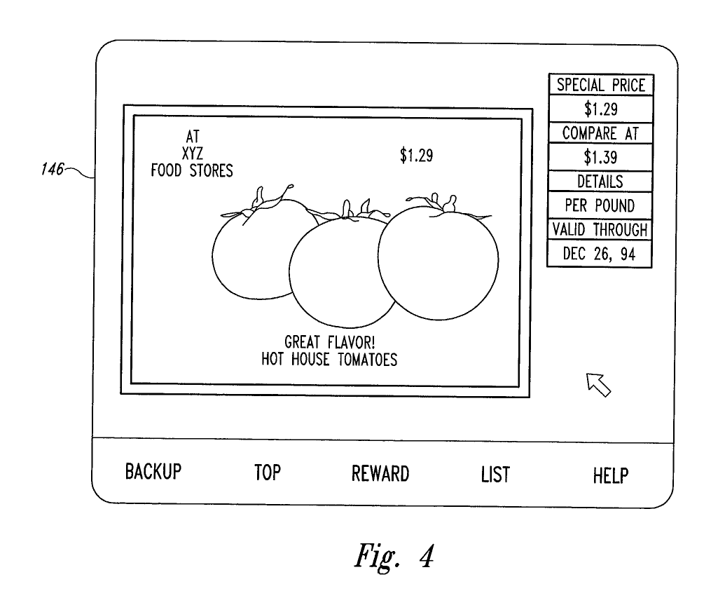

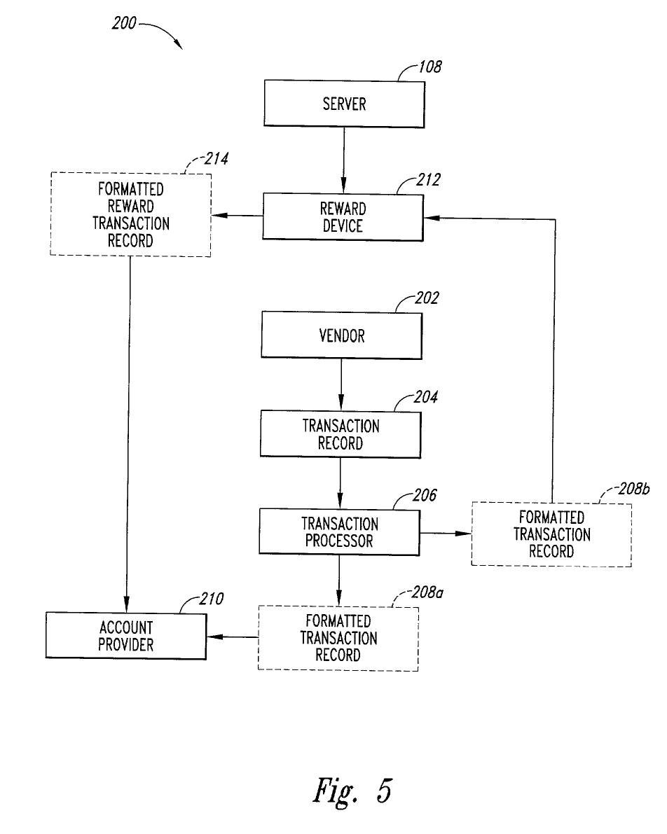

Referring to the drawings in detail, wherein like numerals are used to indicate like elements throughout, there is shown in FIG. 1 an interactive promotion system 100 for accessing and presenting promotions to a user at the user's remote location and for generating automatic purchase rewards (in conjunction with the reward system 200 shown in FIG. 5) based on the promotions in accordance with a preferred embodiment of the present invention. The system 100 is a subscriber-based system that allows a user-subscriber to selectively choose from a plurality of promotions during a promotion browsing session with the aid of the user's own personal or other computer or PC appliance (“user PC”) 102 at the user's remote location (i.e., the user's home, office, etc.), where the chosen promotions are presented on the user PC 102. Each promotion includes an offer from a vendor 202 (FIG. 5) in connection with one or more products or services (“product/service”) the vendor 202 sells, leases, distributes, renders, or otherwise provides, and visual and/or audio information related to the product/service being promoted. An example of such visual information 146 is shown in FIG. 4. Each promotion may be ongoing or may be time sensitive, and may be a percentage discount, a dollar cost discount, a special price, location sensitive, etc. Each vendor 202 may be a retail or wholesale store merchant vendor, a manufacturing or outlet merchant vendor, a service merchant vendor, or the like.

Preferably, the information for each promotion is in the form of a promotion information record, where each promotion information record includes listings, specifications, prices, discounts and other information about the promotion (“detail information”). The promotion information for each promotion information record may be in the form of textual information, graphic information, video information, and/or audio information relating to the products/services and/or the vendor being promoted.

Preferably, at least a portion of each of a plurality of the promotion information records are delivered to each user in the form of at least one CD-ROM disk 104 which is played on a CD-ROM drive 106 connected to or associated with the user PC 102. More preferably, the higher bandwidth information for each of the plurality of promotion information records, such as the graphic information, video information, and/or audio information, is stored on the CD-ROM disk 104, and the lower bandwidth information (including the detail information) is available only from a central server 108. Accordingly, it is preferable that the user be connected to the server 108 during each promotion browsing session. As should be understood, a promotion information record can likely be presented to the user more efficiently when the bulk of the information (the high bandwidth information) is on a CD-ROM disk 104 local to the user PC 102. Nevertheless, one skilled in the art will appreciate that other routes and methods for delivering the promotion information recorded may be employed without departing from the spirit and scope of the present invention.

The CD-ROM disk 104 is preferably delivered to each user periodically (e.g., monthly, every six weeks), on a subscription basis. The promotion information on the CD-ROM disk 104 delivered to a particular user has only some general demographic relevance to that user. That is, the contents of the CD-ROM disk 104 are not highly individualized, and many people in a particular geographic area may receive identical CD-ROM disks 104. Accordingly, the CD-ROM disks 104 can be mass-produced.

Preferably, the lower bandwidth information (including the detail information) on the server 108 may be updated with update information as necessary before the user is provided with a new CD-ROM disk 104. For example, such update information may include a new purchase price for a product/service, or a new, different reward in connection with the promotion, among other things. Also preferably, new promotion information records may be supplied as new information from the server 108 directly to the user before the user is provided with a new CD-ROM disk 104. As may be understood, such new information would likely not include the higher bandwidth information normally stored on the CD-ROM disk 104. Accordingly, changes to promotions and new promotions may be quickly effectuated.

As seen in FIG. 1, the server 108 may be connected to the user PC 102 either directly by a direct dial-up service 110, indirectly by a network dial-up (non-Internet) service provider 112, through the Internet by an Internet service provider 114, or the like. If the Internet is employed, it is preferable that the system 100 include a web server 142 connected to or associated with the system server 108 to facilitate such Internet connection.

As should be understood, in an alternate embodiment of the present invention, the server 108 can provide the promotion information records directly to the user PC 102 during the session, and the CD-ROM disk 104 and CD-ROM drive 106 can be dispensed with. If a relatively large amount of information is to be downloaded from the server 108 during a session, it is preferable that only a portion of such information be initially provided, and that additional information be provided only if the user so requests. The portion of such information provided may be portions of each of several promotion information records, complete versions of selected promotion information records, or the like.

Preferably, the server 108 is one or more UNIX computers acting as servers. Preferably, the server 108 includes or is interfaced to an authoring system 140 to author the promotion information in a form that can be accessed by the user PC 102. As should be understood, the authored promotion information preferably resides on a vendor promotions database 134 connected to or associated with the server 108 and is employed to produce the CD-ROM disk 104. As seen in FIG. 1, the authoring system 140 has access to an advertising media database 144 for obtaining advertising media data necessary to author the promotion information.

Preferably, the user employs a “navigator” to browse the promotions based on user-defined search criteria. Also preferably, the promotions are presented to the user in a manner customized to that particular users interests, in accordance with a user profile for that user. More specifically, the server 108 includes or has access to a user profile database 116 with user profile data for each user of the system 100. Based on the user profile for a particular user, that user is guided to but not limited in browsing the promotions.

Preferably, an initial user profile is generated by the server 108 based upon a questionnaire completed by the user upon first using the system 100, although it will be recognized that the questionnaire could be completed at other appropriate times and by other means without departing from the spirit and scope of the present invention. To complete the questionnaire, the server 108 prompts the user to provide basic information by which the presentation of promotion information can be tailored. For example, the user may be asked for information relating to the user's income, family, dates such as anniversaries and birthdays, special interests, product preferences, types of automobiles owned, and type of residence, among other things. With the user profile for each user, the server 108 may target certain promotions to certain users based on factors such as income, product preferences, geographic location, and the like.

Preferably, a user profile for a user not only guides the user in accessing promotions but is updated upon the user's accessing of promotions to reflect such accessions. Accordingly, the user profile for the user can change with the user and can adapt to new wants and needs that the user may have. For example, a user that accesses a number of promotions for a certain type of automobile may be presumed to be interested in purchasing such type of automobile, and the user profile for such user can be updated accordingly. Preferably, the user profile for the user is dynamically updated during each promotion browsing session in response to each user accession, as appropriate.

In an alternate embodiment of the present invention, the user is not continuously connected to the server 108 during each promotion browsing session. Instead, the session is based only on promotion information available on the CD-ROM disk 104 at the user PC 102. In such an alternate embodiment, the user profile for the user is preferably downloaded to the user from the user profile database 116 by way of the server 108 each time that user logs on to the system 100. Prior to the user logging off the system 100 or at some time after the session is completed, the updated user profile data for the user is uploaded to the user profile database 116 by way of the server 108.

In the preferred embodiment of the present invention, and again referring to FIG. 1, the server 108 also stores user account data, vendor billing data, and vendor account data in respective databases 132, 136, 138. Such databases allow the server 108 to add new users and vendors 202 to the system, and to bill each vendor 202 and user for use of the system. Preferably, the server is linked to individual vendor computers (not shown) for updating promotion information and the like.

As may be understood, the databases 116, 118, 132, 134, 136, 138 may be organized geographically or by other means. Further, more than one server 108 may be employed, where each server 108 preferably is dedicated to one area (geographic or otherwise). If servers 108 are geographically allocated, each server 108 preferably contains user information relative to users in the respective geographic region.

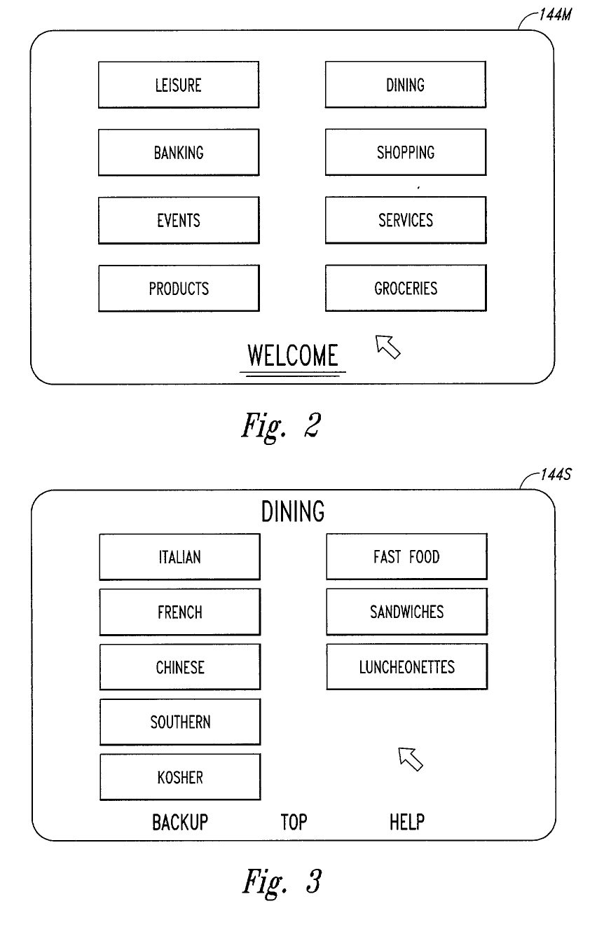

Preferably, the promotion information records are presented to the user such that the user navigates to browse the promotions by way of a hierarchical structure of menus. For example, and as seen in FIG. 2, when the user first enters the system 100 (by, for example, powering up the user PC 102 and executing a local program on the user PC 102), a main menu 144M is displayed on the user PC 102. Additionally, a welcoming audio signal may be reproduced on speakers 124 associated with the user PC 102. Preferably, the start time is logged as user information in the user profile for the user. The main menu may have a list of different areas of interest to the user (e.g., leisure, dining, shopping, events, services, products, groceries). The user has the option of selecting any item listed in the main menu 144M.

Typically, and as seen in FIG. 3, such selection would result in the display of one of several sub-menus 144S listing more specific choices from which the user could select. For example, a dining sub-menu 144S may list different types of restaurants (e.g. fast food, sandwich shops, luncheonettes, etc.) and/or different types of available food (e.g., Italian, French, Chinese, Southern, Kosher). As may be understood, the user navigates through the hierarchical structure of menus until he or she can actually view and/or listen to promotion information records for each of several available products/services. Preferably, and as seen in FIG. 3, each sub-menu 144S in the system contains options that the user may employ to navigate the hierarchical structure and to obtain answers to queries regarding the use of the system.

The user may navigate based on a particular product from any vendor 202, based upon promotions offered by a particular vendor 202, and/or based on system suggestions derived from the user profile for the user or in response to extended search queries from the user. Information pertaining to the user's navigation of the menus and sub-menus 144M, 144S is dynamically stored in the user profile for the user as the session proceeds.

Preferably, in any sub-menu, the order of presentation of the choices that the user may select from is based on the user profile for the user. For example, if the user profile for the user indicates that the user usually chooses a first store and almost never chooses a second, similar store, the user profile for the user would require that the first store be listed or ordered before the second store if both stores appear in the same sub-menu.

Preferably, the system is dynamic and can create user-specific hierarchical branches based on the user profile for the user. For example, if the user frequently selects promotions from a particular store, those frequently selected promotions may be organized into a specific sub-menu under a sub-menu relating to the particular store.

One skilled in the art will recognize that presentation means other than hierarchical presentation means may be employed without departing from the spirit and scope of the present invention. Moreover, such presentation means may be physically remote from the other elements of the system 100. For example, and as an alternative, the presentation means may comprise a virtual shopping center or the like accessed by an interactive network such as the Internet. In such a case, the virtual shopping center would preferably be a network site and would include appropriate ‘jumps’ to a network site connected to the system 100.

In response to the user having chosen a specific promotion for presentation, and as seen in FIG. 4, visual information 146 from the promotion information record relating to the selected promotion is presented on the user PC 102. If the promotion information record relating to the selected promotion also contains audio information, such audio information is presented via the speakers 124 associated with the user PC 102.

Preferably, a user may selectively prevent the listing and presentation of certain specific types of promotions or groups of promotions. For example, if the user is a male, he may not care to be bothered with promotions for female-oriented products. Likewise, the user may not want to see promotions for certain adult-oriented products/services. Such repudiated types of promotions would then be appropriately noted in the user profile for the user.

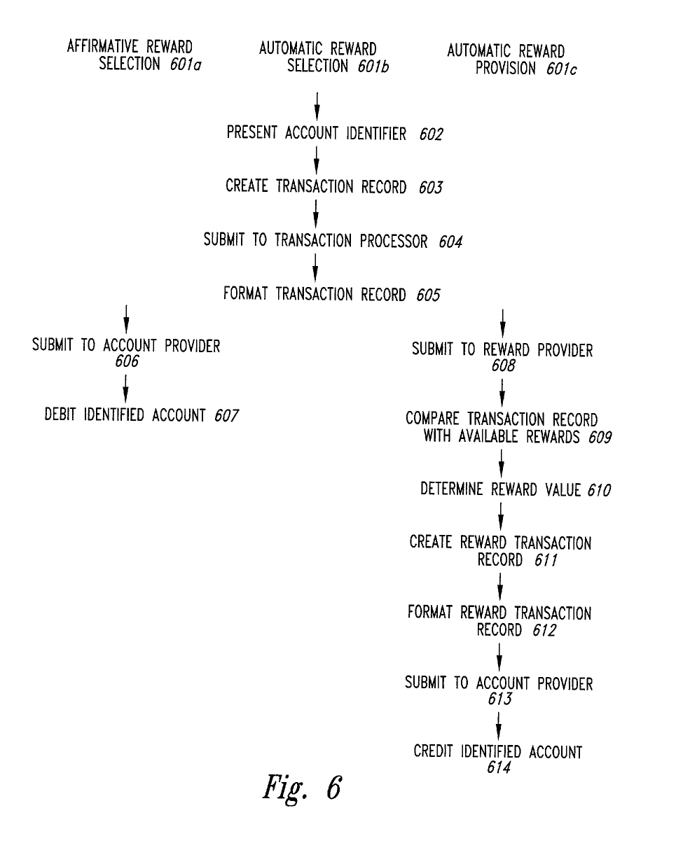

Preferably, and still referring to FIG. 4, each displayed promotion contains a “reward” option. When the user wishes to take advantage of a promotion and affirmatively select a reward (step 601a in FIG. 6), the user selects the reward option and the available reward is electronically stored in an available reward database 118 connected to or associated with the server 108. As one skilled in the art will appreciate, the reward of a particular promotion may be provided based on the purchase of any product/service from a particular vendor 202 (FIG. 5), the purchase of a particular product/service from any vendor 202, and all variations thereof. As should be understood, the available reward is not actually provided unless and until the user complies with the requirements necessary to obtain the available reward (e.g., purchasing any product/service from a particular vendor 202). Preferably, the available reward database 118 is organized according to the user profiles in the user profile database 116. More preferably, the user profile database 116 includes the available reward database 118 and the available reward is stored in the available reward database 118 in connection with the user profile for the user.

Preferably, in addition to the affirmative selection of an available reward by the user as discussed above (step 601a in FIG. 6), rewards may be provided to the user in any of several other ways without departing from the spirit and scope of the present invention. For example, it may be desirable to have the system 100 select a reward for the user automatically (step 601b) merely upon the user navigating to a corresponding promotion. Likewise, it may be desirable to automatically provide a reward to a user (step 601c) without requiring the user to take any action on his or her part. For example, a particular reward may be provided to all system users, all male system users, systems users having a particular zip code range, and/or to any of a plurality of other kinds of system users, as may be desirable.

Preferably, each displayed promotion also contains a “list” option that, when selected, adds the promoted product/service and/or vendor to a “shopping list”. Such a shopping list may then be printed on a printer 126 connected to or associated with the user PC 102. The printer 126 may also be employed to print out promotion-related information including maps, addresses, telephone numbers, and the like.

To redeem an available reward, the user must perform the actions required, e.g., making any purchase from a particular vendor 202 on a particular day, etc. In connection with the aforementioned purchase, the purchaser/user preferably presents a pre-determined account identifier 120 to the vendor 202 (step 602 in FIG. 6), where the account identifier 120 identifies an account of the purchaser from which funds are to be debited and transferred to the vendor 202. As should be understood, the account is maintained and provided to the purchaser by an account provider 210 (FIG. 6). As should also be understood, the account identifier 120 is a pre-determined one since the reward device 212 (FIG. 5, to be described below) will employ the account identifier 120 to determine that the user is in fact a system user. Typically, the account identifier 120 is a credit card number, a debit card number, a charge card number, or the like from a financial card, and the account provider 210 is the card provider. However, one skilled in the art will appreciate that other forms of account identifier 120 may be employed without departing from the spirit and scope of the present invention. For example, the purchaser's account identifier 120 may be an actual bank account or other account at a financial institution, or the like, or may even be a smart card having on-board memory and processing capabilities.

Typically, a vendor 202 has an account identifier/card reader 122 for reading the account identifier 120 and other indicia from a financial card, for communicating the account identifier 120 and other indicia to a verifying and/or approving agent (not shown), and for causing a transaction receipt printer 130 to print an appropriate transaction receipt based on the purchase, the account identifier 120, and other indicia including a verifying and/or approving code. As one skilled in the art will recognize, the reader 122 may be any of several well known readers available to vendors 202 without departing from the spirit and scope of the present invention. For example, the reader 122 may be the ubiquitous credit card authorization and approval device found at most vendors 202.

As should be understood, the purchaser need not be physically present at the vendor 202 to provide the account identifier 120. For example, the vendor 202 may accept the account identifier 120 from the purchaser orally over the telephone or the like, electronically by way of the Internet, an electronic bulletin board system (BBS), an electronic mail (E-mail) system, or the like. Importantly, the vendor 202 need not communicate with the server 108 during the purchase transaction and need not have any unusual equipment to effectuate redemption of any available reward. Likewise, the user need not carry any special identification and need not review or otherwise affirmatively indicate to the merchant 202 that an available reward is to be redeemed. Moreover, no paper copy of the redeemed available reward is printed since no paper trail is believed to be necessary.

Preferably, and referring now to FIG. 6, the vendor 202 creates a transaction record 204 as part of the purchase transaction for which an available reward is to be provided (step 603 in FIG. 6). As is known, such transaction record 204 is customarily submitted for receipt and payment by the account provider 210 providing the identified account, as will be described in more detail below. In fact, the transaction record 204 may be the transaction record created in most if not all credit card, debt card, or charge card purchase. Typically, the transaction record 204 includes the name of the vendor 202, an account identifier 120, a first amount of funds to be debited from the identified account with respect to the purchase, purchase date/time information, etc. However, one skilled in the art will appreciate that the transaction record 204 may also include other pertinent information, including but not limited to an identification of the actual product/service purchased, an approval code, and the like.

The created transaction record 204 is then submitted by the vendor 202 for receipt by the account provider 210 (step 606 in FIG. 6) and also for receipt by a reward device 212 (FIG. 5) associated with a reward provider (step 608 in FIG. 6). As should be understood, the submitted transaction record 204 is received by the account provider 210 and by the reward device 212 after being processed and forwarded through a clearing housing or the like. One typical method by which such receipt occurs is that the transaction record is submitted by the vendor 202 along with several other transaction records to a commercial transaction processor 206 (FIG. 5) (step 604 in FIG. 6). As is known, such transaction processor 206 organizes all of the submitted transaction records including the transaction record 204 into formatted transaction records including a formatted transaction record 208a (FIG. 5) corresponding to the transaction record 204 (step 605 in FIG. 6). Such organizing and formatting is well known and therefore need not be discussed in any further detail.

The formatted transaction record 208a may then be submitted to the account provider 210 along with other formatted transaction records for the account provider 210 for further processing (step 606 in FIG. 6), and to the reward device 212 along with other formatted transaction records for the reward device 212 for further processing (step 608 in FIG. 6). With regard to the account provider 210, and as is known, such further processing includes further verification of the formatted transaction record 208, debiting of the account identified by the account identifier 120 in the formatted transaction record 208a (step 607 in FIG. 6), etc. Of course, as part of the processing of the transaction record 204/formatted transaction record 208a, a credit is ultimately provided by the account provider 210 to the vendor 202, where the credit is payment for the purchase by the purchaser that resulted in the transaction record 204.

As should be understood, other methods of submitting the transaction record 204 for receipt by the account provider 210 may be employed without departing from the spirit and scope of the present invention. For example, the vendor 202 may act as its own transaction processor 206, thereby avoiding the need to submit the transaction record 204 to a transaction processor. Instead, the vendor 202 would organize the transaction record 204 into the formatted transaction record 208a itself and then submit the formatted transaction record 208a for receipt by the account provider 210. Moreover, one skilled in the art will appreciate that the submitted formatted transaction record 208 need not necessarily be received directly by the account provider 210 from the vendor 202 or the transaction processor 206 without departing from the spirit and scope of the present invention. If an intermediate clearing housing is employed, for example, the formatted transaction record may be received by one or more additional entities prior to being received by the account provided 210.

As shown in FIG. 5, a first copy of the formatted transaction record 208a is created for receipt by the account provider 210 and a second copy of the formatted transaction record 208b is created for receipt by the reward device 212. However, one skilled in the art will realize that other variations may also be employed without departing from the spirit and scope of the present invention. For example, only a single formatted transaction record may be created for receipt by both the account provider 210 and the reward device 212, among other things.

As should now be evident, the formatted transaction record 208b received by the reward device 212 associated with the reward provider is employed to generate a reward (if applicable) based on the purchase corresponding to the formatted transaction record 208b and also based on available rewards in the available reward database 118. Although the reward provider operates the reward system 200 and may also operate the promotion system 100 together therewith, one skilled in the art will appreciate that this is not critical, and that in the alternative the promotion system 100 and reward system 200 may be operated separately and by different entities without departing from the spirit and scope of the present invention, so long as the available reward database 118 and other relevant information is accessible to both systems 100, 200.

In the present invention, a participating vendor 202 will likely not know which customers are redeeming available rewards. Moreover, it is to be expected that a vendor 202 will create transaction records 204 in connection with both available reward purchases and non-available reward purchases (e.g., traditional credit card transactions and the like), especially if the account identifier 120 is a traditional credit card account identifier and the transaction record 204 is a traditional transaction record. Accordingly, both reward transaction records (i.e., transaction records 204 for which reward are to be provided) and non-reward transaction records will be periodically submitted by the vendor 202 for receipt by multiple account providers 210. Since the vendor 202 will not know which transaction records 204 are reward transaction records, it is preferable that formatted transaction records 208b be created for all submitted transaction records 204 from each participating vendor 202, and that the reward device 212 determine which formatted transaction records 208b are reward formatted transaction records. One skilled in the art will realize, however, that other means may be employed to make such a determination. For example, the transaction processor 206 may make such a determination if given access to relevant information from the systems 100, 200. In such a case, it is preferable that formatted transaction records 208b be created only for submitted reward transaction records 204.

Once a formatted transaction record 208b is received by the reward device 212, the reward device 212 compares the received formatted transaction record 208b with a plurality of available rewards in the available reward database 118 to determine whether a reward should be issued to the purchaser based on the purchase corresponding to the received record 208b and based on a relevant one of the available rewards (step 609 in FIG. 6). Preferably, and as shown in FIGS. 1 and 5, the available rewards in the available reward database 118 and other relevant information are accessible to the reward device 212 by way of the server 108.

Preferably, the reward device 212 determines that a reward is to be issued only if: (1) the account identifier 120 in the record 208b is for an account of an identified system 100 user, as noted in the user profile data database 116 or the user account database 132; (2) the identified user has one or more identified available rewards stored in the available reward database 118; (3) at least one of the identified available rewards is relevant based on information in the record 208b; and (4) information from the record 208b indicates that the conditions for the identified relevant available reward have been met by the identified user. Of course, one skilled in the art will recognize that other steps may be taken in determining whether a reward should be issued without departing from the spirit and scope of the present invention.

Assuming that the reward device 212 has determined that a reward should be issued to the purchaser, it is preferable that the value of the reward be determined by the reward device 212 based on the information in the received transaction record 208b and the relevant available reward as noted in the available reward database 118 (step 610 in FIG. 6). For example, if the relevant reward is a 10 percent discount and the received transaction record 208b indicates that the purchase was for $100, the reward would be $10. Likewise, if the discount was a straight dollar value (i.e., $5; $20 on amounts over $200; $1 per item; etc.) the value of the reward would be so determined.

Since the value of the reward is determined based on the information in the received transaction record 208b, the types of rewards available may be limited if pertinent information for such types of rewards is not available from the transaction record 208b. For example, if the transaction record 208b does not provide information on the specific products/services purchased, a reward based on the purchase of a specific product/service cannot be provided. Likewise, if the transaction record 208b does not provide information on the time of purchase, a reward based on time cannot be provided.

Assuming that the reward device 212 has determined the cash value of the reward, the reward device 212 preferably issues such reward by creating a reward transaction record 214 corresponding to the reward, where the reward transaction record 214 includes the account identifier 120 associated with the received transaction record 208b and a second amount of funds to be credited to the identified account with respect to the reward (step 611 in FIG. 6).

Preferably, the reward device 212 organizes the reward transaction record 214 into a formatted reward transaction record 214 such that the formatted reward transaction record 214 may be submitted for receipt by the account provider 210 (steps 612 and 613 in FIG. 6). Of course, one skilled in the art will recognize that the reward transaction record 214 may also be submitted to a transaction processor not unlike the transaction processor 206 for such formatting. Once received, the account provider 210 then credits the account identified in the formatted reward transaction record 214 for the second amount of funds, in a manner akin to that discussed above with regard to the formatted transaction record 208a.

As should now be understood, in the system of the present invention, a reward for a purchase is provided by crediting an account that has been previously debited in connection with the purchase that triggered the reward. Of course, one skilled in the art will also recognize that the account credited may differ from the account debited without departing from the spirit and scope of the invention. For example, the account debited may be a credit card account provided by a first financial institution, while the account credited may be a Christmas club or vacation club account provided by a second financial institution that may be unrelated to the first financial institution. Likewise, although the reward is preferably cash-based, one skilled in the art will recognize that the reward may also be non-cash-based without departing from the spirit and scope of the present invention. For example, the reward may be in the form of bonus points in a bonus points account (e.g., frequent flier mileage points), free products/services (e.g., free videocassette rentals), entries in a sweepstakes contest, or the like.

As should be understood, the cost of each credited reward to the reward system 200 includes the actual value of the reward and transaction fees charged by the transaction processor 206, account provider 210, and others to process the credited reward, among other things. Preferably, one of the vendors 202 is charged the cost of each credited reward as well as an additional reward fee. Such charged vendor 202 may be the retail vendor that conducted the purchase transaction that resulted in the credit, a manufacturing vendor that manufactured a relevant purchased product, or the like. Such cost and reward fee may for example be collected from the vendor 202 by gaining permission to have the reward device 212 directly debit a settlement account (not shown) of the vendor 202. Alternatively, such cost and reward fee may for example be collected from the vendor 202 by having the reward device 212 issue a transaction record (not shown) debiting an account of the vendor 202, in a manner akin to that described above with respect to debiting a user's identified account by way of a transaction record 204. However, one skilled in the art will recognize that many other means are available for collecting such cost and reward fee without departing from the spirit and scope of the present invention.

When an available reward is credited to the identified account of a user, it is preferable that the user profile for the user in the user profile database 116 be updated with appropriate information in response. Additionally, the user profile for the user may be updated with any bonuses that may be available in connection with the credited reward. For example, the user may be provided with bonus points that are redeemable for prizes, may be credited a dollar amount as against a user fee, and/or the like, where such bonus points are in addition to the credited reward. It may also be preferable that the user be notified when a reward is credited. To do so, it is preferable that the system 100 automatically sends an electronic mail (E-mail) message to a predetermined electronic mail mailbox of the user. Of course, other types of notification may also be employed without departing from the spirit and scope of the present invention. For example, the system 100 may send a post card by regular mail to the user, or may telephone the user by way of an appropriate electronic caller, among other things.

Preferably, the user may update his or her own user profile as necessary. For example, the user may request a specific type of promotion and/or indicate that he or she wishes to be presented with promotions from a specific geographic area. If the server 108 determines from the updated profile that appropriate promotion information records are not stored on the CD-ROM disk 104 local to the user, then the user can direct the server 108 to undertake an extended search, including interfacing with other central servers 108, perhaps those in other geographic areas.

Preferably, at appropriate times in relation to events noted in the user profile for the user (e.g., an anniversary, a birthday) the central server 108 causes the user to be guided to product/service information pertaining to the occasion. For example, the user may be guided to promotions regarding an anniversary gift several days before an anniversary.

As one skilled in the art will appreciate, the software necessary to operate the user PC 102, the server 108, the vendor device 122, and the other elements of the system 100 is not complex or unusual. In fact, significant parts of such software may be obtained off-the-shelf. For example, the communications between the elements may be accomplished by way of any of several well known communications software systems, while the database operations performed by the server 108 may be performed by any of several well known database software systems. Accordingly, the methods and steps performed by such software should be apparent to one having ordinary skill in the art, and no software flow diagrams or the like are believed necessary or are included as part of the present disclosure.

From the foregoing description, it can be seen that the present invention comprises a new and useful system and method for providing a reward to a purchaser. It will be appreciated by those skilled in the art that changes can be made to the embodiments described above without departing from the broad inventive concepts thereof. It is understood, therefore, that this invention is not limited to the particular embodiments disclosed but is intended to cover modifications within the spirit and scope of the present invention as defined by the appended claims.

1. A method for providing a reward to a purchaser in response to the purchaser making a purchase from a vendor, the method comprising the steps of:
presenting, by the purchaser, a predetermined account identifier to the vendor, the account identifier identifying an account of the purchaser from which funds are to be transferred to the vendor, the account being maintained and provided to the purchaser by an account provider;
creating, by the vendor, a transaction record corresponding to the purchase, the transaction record including the account identifier and a first amount of funds to be debited from the identified account with respect to the purchase;
submitting, by the vendor, the transaction record for receipt by the account provider and also for receipt by a reward provider;
debiting, by the account provider, the identified account for the first amount of funds based on the received transaction record;
comparing, by the reward provider, the received transaction record with a plurality of available rewards to determine that the reward should be issued to the purchaser based on the purchase corresponding to the received transaction record and based on a relevant one of the available rewards;
creating, by the reward provider, a reward transaction record corresponding to the reward, the reward transaction record including the account identifier and a second amount of funds to be credited to the identified account with respect to the reward;
submitting, by the reward provider, the reward transaction record for receipt by the account provider; and
crediting, by the account provider, the identified account for the second amount of funds based on the received reward transaction record.

2. The method of claim I wherein the step of submitting, by the vendor, the transaction record for receipt by the account provider comprises:
submitting, by the vendor, the transaction record to a transaction processor;
organizing, by the transaction processor, the transaction record into a formatted transaction record; and
submitting, by the transaction processor, a first copy of the formatted transaction record for receipt by the account provider.

3. The method of claim 2 wherein the step of submitting, by the reward provider, the reward transaction record for receipt by the account provider comprises:
organizing, by the reward provider, the reward transaction record into a formatted reward transaction record; and
submitting, by the reward provider, the formatted reward transaction record for receipt by the account provider.

4. The method of claim 1 wherein the plurality of available rewards is selected from a group consisting of at least one available reward previously affirmatively selected by the purchaser, at least one available reward previously automatically selected for the purchaser upon an action of the purchaser, at least one available reward automatically available to the purchaser without any action on the part of the purchaser, and all combinations thereof.

5. The method of claim 1 further comprising the step of determining, by the reward provider, a value of the reward based on the received transaction record and the relevant available reward.

6. The method of claim 1 further comprising the step of notifying the purchaser that the reward has been credited thereto.

7. A system for accessing promotional information and for generating available rewards therefrom, the system comprising:
promotion information record storing means for storing a plurality of promotion information records, each promotion information record including an available reward in connection with a purchase from a vendor;
user profile storing means for storing a user profile for a system user, the user profile including user preference information based on preferences of the user;
presentation means for presenting the stored promotion information records to the system user, where the user selects promotion information records for presentation;
selecting means for selecting the available reward of a promotion information record for the user;
available reward storing means for storing the selected available reward for the user, the record of the available reward being stored in an available reward record database in connection with the user profile for the user; and
reward issuing means for issuing a reward to the user upon presentation by the user of a predetermined account identifier to a vendor in connection with a purchase for which the available reward has been stored for the user in the available reward storing means, the account identifier identifying an account of the user from which funds are to be transferred to the vendor, the account being maintained and provided to the user by an account provider, the reward issuing means including:
means for receiving a transaction record corresponding to the purchase, the transaction record including the account identifier and a first amount of funds to be debited from the identified account with respect to the purchase;
means for comparing the received transaction record with the available reward for the user in the available reward storing means to determine that the reward should be issued to the user based on the purchase corresponding to the received transaction record and based on the available reward for the user; and
means for crediting the identified account for a second amount of funds based on the reward.

8. The system of claim 7 wherein the means for crediting further comprises:
means for creating a reward transaction record corresponding to the reward, the reward transaction record including the account identifier and a second amount of funds to be credited to the identified account with respect to the reward; and
means for submitting the reward transaction record for receipt by the account provider.

9. The system of claim 7 wherein the reward issuing means further comprises means for determining a value of the reward based on the received transaction record and based on the relevant record of the available reward.

10. The system of claim 7 wherein the selecting means selects the available reward of a promotion information record for the user upon a scenario selected from the group consisting of an affirmative selection of the available reward by the user, the user selecting the promotion information record for presentation, or without any action on the part of the user.

11. The system of claim 7 wherein the presentation means comprises means for presenting the stored promotion information records to the system user according to a hierarchical menu structure, the hierarchical menu structure including a main menu and a plurality of hierarchically linked sub-menus, each sub-menu including a plurality of choices, where the user navigates the hierarchical menu structure to select promotion information records for presentation.

12. The system of claim 7 wherein the presentation means comprises a first, remote network site on an interactive network, the first site including a jump to a second, system network site.

13. The system of claim 7 wherein the account identifier presented by the user is selected from the group consisting of a charge plate number, a credit card number, a debit card number, and a number of a smart card having a memory and a processor.

14. The system of claim 7 wherein the user profile for the user also includes user presentation information based on promotion information records selected for presentation to the user.

15. The system of claim 14 wherein the user profile for the user further includes obtained reward information based on at least one reward previously obtained by the user.

16. The system of claim 7 wherein each promotion information record includes information selected from the group consisting of textual information, graphic information, video information, audio information, and combinations thereof.

17. The system of claim 7 wherein the promotion information record storing means includes a CD-ROM disk which is played on a CD-ROM drive connected to a user PC located at a remote user site.

18. The system of claim 17 wherein the promotion information records stored on the CD-ROM disk are supplemented with new promotion information, and wherein the user PC at the remote user site is communicatively connected to a central system server, the new promotion information being downloaded from the central system server to the user PC at the remote user site.

19. The system of claim 18 wherein the user PC at the remote user site is communicatively connected to the central system server by a means selected from the group consisting of a direct dial-up service, a network dial-up service provider, and an Internet service provider.

20. The system of claim 7 wherein the promotion information record storing means includes a promotion information record database communicatively connected to a central system server, the central system server being communicatively connected to a user PC located at a remote user site.

21. The system of claim 20 further comprising an authoring system communicatively connected to the server, the authoring system for authoring the promotion information records in a form that can be accessed by the user PC.

22. The system of claim 21 wherein the authoring system produces a CD-ROM disk, the CD-ROM disk for being played on a CD-ROM drive connected to the user PC.

23. The system of claim 7 wherein the user profile storing means includes a user profile database communicatively connected to a central system server, the central system server being communicatively connected to a user PC located at a remote user site, the user profile in the user profile database being dynamically updated based on a promotion information record selected for presentation to the user to reflect such selection.

24. The system of claim 7 wherein the user profile storing means includes a user profile database communicatively connected to a central system server, the central system server being communicatively connected to a user PC located at a remote user site, the user profile being downloaded from the central system server to the user PC at the remote user site each time the user logs on to the system, the downloaded user profile being updated based on a promotion information record selected for presentation to the user to reflect such selection, the updated user profile being uploaded from the user PC to the server for storage in the user profile database prior to the user logging off the system.

25. The system of claim 7 wherein the promotion information record storing means includes a plurality of promotion information record databases, each promotion information record database being communicatively connected to at least one of a plurality of system servers, each system server being communicatively connected to every other system server, one of the system servers being communicatively connected to a user PC located at a remote user site.

26. The system of claim 25 wherein each of the plurality of promotion information record databases contains information relevant to a respective geographic region.

27. The system of claim 7 further comprising repudiation means for allowing the user to selectively prevent the presentation means from presenting predefined types of stored promotion information records to the user.

28. The method of claim 7 further comprising notifying means for notifying the user that the reward has been credited thereto.
